(19) United States
(12) Patent Application Publication
(10) Pub. No.: US 2007/0085431 A1
(43) Pub. Date: Apr. 19, 2007

(54) MOTOR, RECORDING DISK DRIVING DEVICE USING THE SAME, AND METHOD OF MANUFACTURING THEREOF

(76) Inventors: Masamichi HAYAKAWA, Kyoto (JP); Takashi Yamamoto, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(21) Appl. No.: 11/278,906

(22) Filed: Apr. 6, 2006

(30) Foreign Application Priority Data
Apr. 7, 2005 (JP) JP2005-110720
Apr. 4, 2006 (JP) JP2005-103284

(51) Int. Cl. H02K 5/10; H02K 5/16; G11B 17/08

(52) U.S. Cl. 310/90; 29/596; 310/88; 360/98.08

(57) ABSTRACT

A method of manufacturing a spindle motor including a rotor hub having a hard disk placing portion, a base to which the rotor hub is rotatably attached via a bearing, and a coil inducing a magnetic field when energized and arranged at an inside space between the rotor hub and the base, and whose inside space is separated from the outside space by a substantially circular gap maintained between the rotor hub and the base, is provided. The spindle motor preferably includes one or more waterproofed portions including at least a portion of a surface of the rotor hub and a surface of the base facing each other and defining the gap connecting the inside space and the outside space of the spindle motor.

### BACKGROUND OF THE INVENTION

1. Field of the Invention

The present invention generally relates to a motor, and more particularly relates to a spindle motor used for a recording disk driving device. The present invention also relates to a recording disk driving device including the motor. The present invention also relates to a method of manufacturing the motor and a method of manufacturing the recording disk driving device including the motor.

2. Description of the Related Art

Generally, a conventional motor used to rotate a recording disk such as a magnetic disk includes a rotor and a sleeve. A rotary magnet is fixed to the rotor as a rotation member, and a stator is fixed to the sleeve as a stationary member. The rotor includes a rotating shaft arranged at an inner side of the sleeve. One end of the rotating shaft protrudes from the sleeve, and a rotor hub on which the recording disk is placed is fixed to the one end of the rotating shaft. The sleeve is a rotation supporting member which rotatably supports the rotating shaft. The sleeve is fixed to a base by using any suitable fixing device or process, such as, press fitting, adhesives, welding, or a combination thereof.

A recording disk driving device, including the motor mentioned above, is furnished with a head arranged adjacent to the recording disk for reading/writing information from/to the recording disk. Since the recording disk and the head are arranged adjacent to each other, dust particles sticking to the head, the recording disk, or between thereof may cause a device error. Therefore, it is necessary to maintain high cleanliness within an inside space of the recording disk driving device to prevent the device error. In order to maintain high cleanliness, it is necessary not only to shield the inside space from the outside, but also to prevent dust particles from being generated within the inside space of the recording disk driving device.

A method of manufacturing a conventional motor is as follows. Firstly, to remove unwanted oils and dust particles sticking to surfaces of the components, each component is washed with a cleaning liquid. Secondly, the components are assembled into the motor as a final product under the condition where high cleanliness is maintained, such as the inside of a clean room.

If the motor is washed after assembling thereof, the cleaning liquid may infiltrate into the motor and cause short circuits of an electric circuit of the motor. Also, the cleaning liquid may infiltrate into an air gap of a magnetic circuit, and it may be difficult to discharge the liquid infiltrated into the air gap. Consequently, after the assembling process of the motor, the dust particles sticking to a surface of the motor during the assembling process cannot be removed by washing with the cleaning liquid. Therefore, according to the conventional method of manufacturing a motor, it is necessary to wash each component of the motor and to assemble them under very clean conditions.

### SUMMARY OF THE INVENTION

In order to overcome the problems described above, preferred embodiments of the present invention provide a method of manufacturing a spindle motor including a rotor hub which has a hard disk placing portion, a base to which the rotor hub is rotatably attached via a bearing, and a coil generating a magnetic field when energized and being enclosed within an inside space between the rotor hub and the base, wherein the inside space of the spindle motor communicates with an outside space of the spindle motor through a circular gap maintained between the base and the rotor hub. The method according to the present preferred embodiment preferably includes an assembling step in which the rotor hub, the bearing, the coil, and the base are arranged at predetermined positions and are assembled into a motor assembly; a motor assembly washing step in which the motor assembly is washed by using a cleaning liquid with the circular gap being exposed to the cleaning liquid; and a motor assembly drying step in which the motor assembly washed by using a cleaning liquid is dried.

According to another preferred embodiment of the present invention, a spindle motor includes a rotor hub which has a hard disk placing portion, a base to which the rotor hub is rotatably attached via a bearing, and a coil generating a magnetic field when energized and being enclosed within an inside space between the rotor hub and the base, wherein the inside space of the spindle motor is connected to an outside space of the spindle motor through a circular gap maintained between the base and the rotor hub. The spindle motor according to the present preferred embodiment preferably includes one or more waterproofed portions which include at least a portion of a surface of the rotor hub and a surface of the base facing each other and defining the circular gap connecting the inside space and the outside space of the spindle motor, at least a portion of a surface of the rotor magnet being exposed to outside air, at least a portion of a stator facing the rotor magnet with a gap maintained therebetween, and at least a portion of an outer circumferential surface of the sleeve facing the rotor hub.

According to another preferred embodiment of the present invention, a method of manufacturing a recording disk driving device includes the spindle motor according to one of the above-described other preferred embodiments of the present invention; a recording disk placed on a recording disk placing portion of the spindle motor; a head locating member having a head for reading/writing information from/to the recording disk; and a housing enclosing the spindle motor, the recording disk, and the head locating member. The method according to the present preferred embodiment preferably includes a washing step in which the spindle motor is washed with a cleaning liquid, and a assembling step in which the spindle motor, the head locating member, and the recording disk are arranged and are assembled into a recording disk driving assembly.

As mentioned above, preferred embodiments of the present invention include the motor which is washable after assembling thereof, the recording disk driving device including the motor, and the method of manufacturing the motor and the recording disk driving device.

In the description of the preferred embodiments of the present invention herein, words such as upper, lower, left, right, upward, downward, top, and bottom for explaining positional relationships between respective members and directions merely indicate positional relationships and directions in the drawings. Such words do not indicate positional relationships and directions of the members mounted in an actual device.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a longitudinal sectional view showing a spindle motor according to a preferred embodiment of the present invention.

FIG. 2 is a longitudinal sectional view schematically showing a structure of the spindle motor according to another preferred embodiment of the present invention.

FIG. 3 is a schematic view of a hard disk driving device according to a preferred embodiment of the present invention.

FIG. 4 is a flow chart of a method of manufacturing a spindle motor according to a preferred embodiment of the present invention.

FIG. 5 is a flow chart of a method of assembling a spindle motor according to a preferred embodiment of the present invention.

### DETAILED DESCRIPTION OF PREFERRED EMBODIMENTS

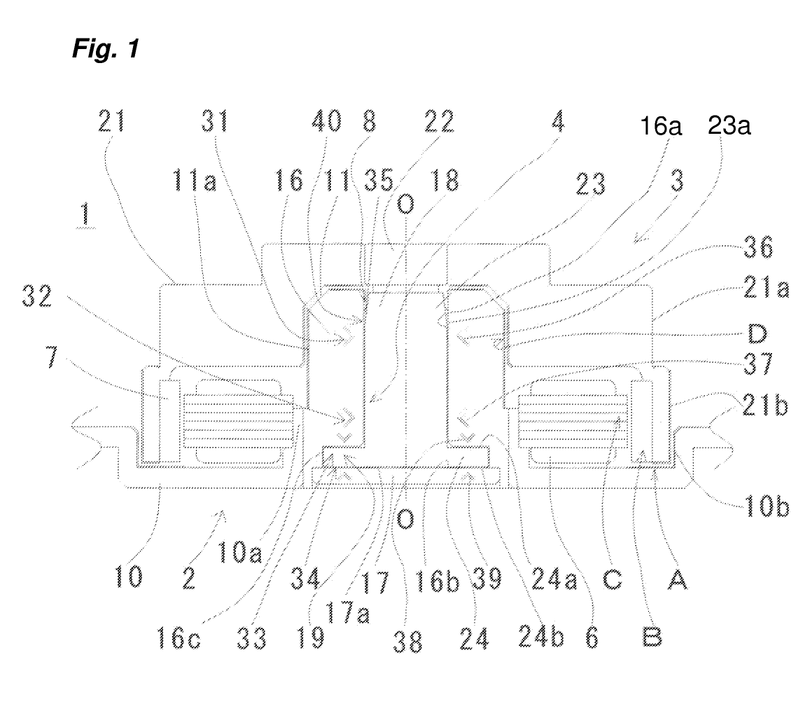

A general structure of a spindle motor 1 according to a preferred embodiment of the present invention is schematically shown in FIG. 1.

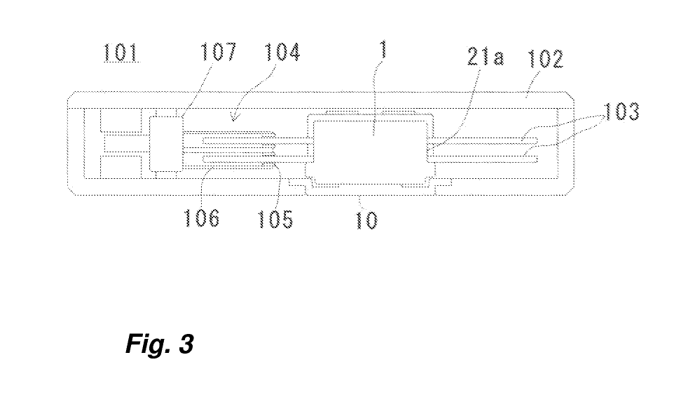

The spindle motor 1 is a spindle motor which rotates a recording disk and is installed into a recording disk driving device such as a hard disk drive. FIG. 3 is a schematic view showing the recording disk driving device furnished with the spindle motor 1. Line O-O shown in FIG. 1 is a rotation axis of the spindle motor 1. In the description of the present preferred embodiment, an axially upward and an axially downward direction indicate an upward and downward direction in FIG. 1. However, such directions do not indicate positional relationships and directions of the members mounted in an actual device.

Composition of the Spindle Motor

The spindle motor 1 preferably includes a stationary member 2, a rotation member 3, and a dynamic bearing 4 which rotatably supports the rotation member 3 relative to the stationary member 2. The spindle motor 1 also includes a stator 6 and a rotor magnet 7. The stator 6 includes a stator core fixed on the stationary member 2 and a coil winding around the stator core. The rotor magnet 7 is fixed to the rotation member 3. The stator 6 interacts with the rotor magnet 7 such that a rotating magnetic field is generated. As a result, torque is applied to the rotation member 3.

Stationary Member

The stationary member 2 preferably includes a base 10 and a sleeve 11. The sleeve 11 is fitted and fixed to a fixing bore which is provided at a middle portion of the base 10. The base 10 is preferably made of an aluminum alloy and the sleeve 11 is preferably made of stainless steel.

The base 10 is a substantially plate shaped member and a lower surface of the base 10 is fixed to a bottom wall of a housing 102 of a hard disk drive 101 (see FIG. 3). On a peripheral portion of the fixing bore, a cylindrical portion 10a extends in an axially upward direction. An outer circumferential surface of the sleeve 11 is fixed preferably with an adhesive to an inner circumferential surface of the cylindrical portion 10a. The stator 6 is fixed to an outer circumferential surface of the cylindrical portion 10a.

The sleeve 11 includes a sleeve body 16 having a hollow cylindrical shape and a thrust cover 17 having a disk shape which occludes a bottom end of the sleeve body 16. The sleeve body 16 includes a through hole 18 which axially extends along a central axis of the sleeve body and has an inner circumferential surface 16a. The thrust cover 17 is a disk shaped member fixed to the bottom end of the sleeve body 16 so as to occlude a bottom opening of the through hole 18. A step portion 19, continuous with the inner circumferential surface 16a, is arranged at the bottom end of the sleeve body 16. The step portion 19 includes a thrust surface 16b which is a bottom end surface of the sleeve body 16 and a bottom inner circumferential surface 16c whose diameter is larger than a diameter of the inner circumferential surface 16a, such that the step portion 19 defines a circular convex space into which a thrust flange 24 of a shaft 22 is inserted. A lower side of the step portion 19 is occluded with a thrust surface 17a which is an axially upper end surface of the thrust cover 17. As described above, the sleeve 11 is defined by the sleeve body 16, the step portion 19 of the sleeve body 16, and the thrust cover 17. The sleeve 11 also includes a disk shape hollow portion whose diameter is larger than a diameter of the cylindrical hollow portion.

Rotating Member

The rotation member 3 is a member rotatably supported by the dynamic bearing 4 relative to the stationary member 2. The rotation member 3 includes the rotor hub 21 on which the recording disk 103 is placed and the shaft 22 which is arranged at an inner circumferential side of the rotor hub 21 and is supported by the sleeve 11 via the dynamic bearing 4.

The rotor hub 21 is a cup shaped member that is arranged adjacent to the sleeve 11 and the stator 6 so as to cover the sleeve 11 and the stator 6 from an upper side thereof. An inner circumferential surface of a boss portion 21a of the rotor hub 21 faces an upper outer circumferential surface of the sleeve 11 with a gap maintained therebetween. The rotor magnet 7 is fixed to an inner circumferential surface of a lower cylindrical portion 21b by any suitable bonding structure, such as with an adhesive. The recording disk 103 is fitted and fixed to an outer circumferential surface of the boss portion 21a.

The rotor magnet 7 radially faces the stator 6 with a gap maintained therebetween. When the coil of the stator 6 is energized, the stator 6 electromagnetically interacts with the rotor magnet 7. As a result, torque acts on the rotation member 3.

An axially upper end portion of the shaft 22 is fitted into a central bore of the rotor hub 21. The thrust flange 24 is integral with a bottom end of the shaft 22. The shaft 22 is defined by the thrust flange 24 and a shaft body 23 which has a cylindrical shape. Most of the shaft body 23 is arranged within the cylindrical shaped hollow portion along the through hole 18 of the sleeve 11. An outer circumferential surface 23a of the shaft body 23 radially faces the inner circumferential surface 16a with a gap maintained therebetween.

The thrust flange 24 is a disk shaped portion arranged at the hollow portion of the sleeve 11. More specifically, the thrust flange 24 is a disk shaped portion which extends radially and outwardly from a bottom end of the outer circumferential surface 23a of the shaft body 23 so as to define a gap between the thrust flange 24 and the bottom inner circumferential surface 16c of the sleeve body 16. The thrust flange 24 includes a first thrust surface 24a adjacent to the shaft body 23 and a second thrust surface 24b on an opposite side from the first thrust surface 24a of the thrust flange 24. The first thrust surface 24a axially opposes the thrust surface 16b which is the bottom surface of sleeve body 16 with a gap maintained therebetween. The second thrust surface 24b axially faces a thrust surface 17a of the thrust cover 17 with a gap maintained therebetween.

Dynamic Bearing

The dynamic bearing 4 is a bearing portion which rotatably supports the rotation member 3 relative to the stationary member 2. More specifically, the dynamic bearing 4 is a bearing portion which rotatably supports the rotor hub 21 and the shaft 22 relative to the sleeve 11 via lubricating oil 8. The dynamic bearing 4 includes a first radial dynamic bearing portion 31 and a second radial dynamic bearing portion 32. The dynamic bearing portion 4 also includes a first thrust dynamic bearing portion 33 and a second thrust dynamic bearing portion 34. Gaps maintained at the aforementioned bearing portions are filled with the lubricating oil 8. The lubricating oil 8 contacts air only at a surface tension seal portion 35 which is provided at an axially upper portion of a gap between the outer circumferential surface of the shaft 22 and the inner circumferential surface of the sleeve 11. Moreover, the gaps defining each dynamic bearing portion 31 to 34 are completely filled with the lubricating oil 8. Such structure is so called a full-fill structure in which the lubricating oil and the outside air define an interface only at the surface tension seal portion 35.

Referring to the structures of the sleeve 11, the thrust cover 17, and the shaft 22, the structure of the dynamic bearing portions 31 to 34 will be described below. The detail of the surface tension seal portion will be described below as well. In FIG. 1, dynamic pressure generating grooves 36 to 39 are illustrated on the cross section of the sleeve 11 and the thrust cover 17. However, it should be understood that these grooves are provided on the surfaces of corresponding members.

Radial Dynamic Bearing Portion

A plurality of dynamic pressure generating grooves are circumferentially arranged on the inner circumferential surface 16a of the sleeve 16 so that rows of the grooves 36 and 37 are arranged in a herringbone shape and are provided on the inner circumferential surface 16a. The rows of grooves 36 and 37 are arranged in an axially spaced manner and induce dynamic pressure with the rotation of the shaft 22. Each dynamic pressure generating groove is defined by a pair of spiral grooves, and each pair of spiral grooves is inclined in opposite directions such that the pair of the spiral grooves has a dogleg shape. As mentioned above, the first and the second radial dynamic bearing portions 31 and 32 are arranged in an axially spaced manner and are defined by the inner circumferential surface of the sleeve body 16, the outer circumferential surface 23a of the shaft body 23, and the lubricating oil 8 maintained between the sleeve body 16 and the shaft body 23. In the first and the second radial dynamic bearing portions 31 and 32, the hydrodynamic pressure becomes maximum at the portion at which each spiral groove of the pair of spiral grooves defining the dynamic pressure generating groove is connected. Therefore, sufficient supporting pressure is attained.

Thrust Dynamic Bearing Portion

A row of grooves 38 is provided on the thrust surface 16b of the sleeve body 16. The row of grooves 38 is defined by a plurality of the dynamic pressure generating grooves which are circumferentially arranged so that the row of grooves 38 is arranged in a herringbone shape. With the rotation of the shaft 22, the row of grooves 38 induces dynamic pressure on the lubricating oil 8. Each dynamic pressure generating groove is defined by a pair of spiral grooves, and each pair of spiral grooves is inclined in opposite directions such that the pair of the spiral grooves defines a dogleg shape. When the rotor rotates, the dynamic pressure generating grooves induce dynamic pressure which axially supports the rotation member 3. As described above, the first thrust dynamic bearing portion 33 is defined by the thrust surface 16a of the sleeve 11, the first thrust surface 24a of the thrust flange 24, and the lubricating oil 8 maintained between the sleeve 11 and the thrust flange 24.

A row of grooves 39 is provided on the thrust surface 17a of the thrust cover 17. The row of grooves 39 is in a spiral shape and induces dynamic pressure on the lubricating oil 8 with the rotation of the shaft 22. The row of grooves 39 is defined by a plurality of dynamic pressure generation grooves arranged in a rotation direction. Each dynamic pressure generating groove of the row of grooves 39 inclines from the rotation direction so as to induce the hydrodynamic pressure forward to a radially inward direction on the lubricating oil 8. As described above, the second dynamic bearing portion 34 is defined by the second thrust surface 24b of the thrust flange 24, the thrust surface 17a of the thrust cover 17, and the lubricating oil 8 maintained between the thrust surface 24b and the thrust surface 17a.

Surface Tension Seal Portion

The surface tension seal portion 35 is an oil leak-proof structure which prevents the lubricating oil 8 from leaking from the first radial dynamic bearing portion 31. The surface tension seal portion 35 is arranged at an upper end portion of the sleeve body 16 and is defined by the inner surface 16a of the sleeve body 16 and the outer circumferential surface 23a of the shaft body 23. More specifically, the surface tension seal portion 35 is defined by a taper portion 40 arranged on the inner surface 16a of the sleeve body 16. The taper portion 40 is provided with a gap between the inner circumferential surface 16a of the sleeve body 16 and the outer circumferential surface 23a of the shaft body 23, wherein the gap expands in the radially outward direction. With the structure mentioned above, the surface tension of the lubricating oil 8 retained within the dynamic bearing 4 is in balance with the outside air pressure. As a result, leakage of the lubricating oil 8 to the outside of the dynamic bearing portion 4 may be prevented.

Characteristic of the Spindle Motor

According to the present preferred embodiment, the following portions of the spindle motor 1 are waterproofed.

An inner circumferential surface 10b, which is the most outward surface of the base 10 facing the rotor hub 21 with the circular gap maintained therebetween, is preferably circularly covered with water-repellent paint, such as U-CP-70 (made by Nippon Paint Co., Ltd.) so as to have water-repellency (first waterproof structure A). A portion of a surface of the rotor magnet 7, which is exposed to the outside air, is covered with a coating material (such as epoxy resin) so as to have water-repellency (second waterproof structure B). The stator 6 facing the rotor magnet 7 with a gap maintained therebetween is preferably covered with a water-repellent resin (a third waterproof structure C). An upper portion of an outer circumferential surface 11a of the sleeve 11 facing the rotor hub 21 is preferably circularly covered with a water-repellent material so as to have water-repellency (a fourth waterproof structure D). More particularly, suitable water-repellent materials include, for example, CYTOP® (Asahi Glass Company, Limited), INT-340 (NI Material, Ltd), or Fluorocoat (Seimi Chemical, Ltd), and such materials may be used in the present preferred embodiment of the present invention. Additionally, a portion of the outer circumferential surface of the rotor hub 21 facing the first waterproof structure A of the base 10 may be covered with a water-repellent material. A portion of the inner circumferential surface of the rotor hub 21 facing the fourth waterproof structure D of the sleeve 11 may be covered with a water-repellent material as well. The waterproof structure may be, for example, a layer provided on the surface of the members. For example, excellent repellence may be advantageously attained by forming the layer with a fluoro compound having a perfluoroalkyl group.

Alternatively, the waterproof structure may be formed by a hydrophilic material, such as, a hydrophilic metal or a hydrophilic resin. Hydrophilicity of the surface of the members inhibits water from flowing on the surface such that water does not flow into the motor.

Each gap dimension where the waterproof structure is provided is respectively about 0.5 mm, and more preferably, each gap dimension is preferably about 0.2 mm. A static contact angle with water of each surface where the waterproof structure is provided is greater than about 20 degrees. With the static contact angle greater than 20 degrees and the gap dimension smaller than 0.5 mm, a sufficient waterproof property may be attained. As mentioned above, the most outward portion of the circular gap through which water and air may flow into the motor have a waterproof property either on the surface of the stationary member 2 or on the surface of the rotation member 3.

The spindle motor 1 includes a magnetic circuit portion which is defined by the stator 6 and rotor magnet 7 and generates torque applied to the rotation member 3. The magnetic circuit portion is enclosed within the base 10 and the rotor hub 21. The most outward portion of the circular gap connecting the inside and the outside of the spindle motor, in other words, the portion of the base 10 where the first waterproof structure A is applied and faces the rotor hub 21 with the circular gap maintained therebetween, has a substantially circular shape, and a cleaning liquid (such as purified water) does not flow into the spindle motor 1 through this portion.

As discussed above, the cleaning liquid does not flow into the spindle motor 1, especially into the dynamic bearing 4, when the spindle motor 1 is washed after assembling thereof. Moreover, the cleaning liquid does not remain in the spindle motor such that the possibility that gas is emitted is decreased. Additionally, contamination which is generated within the spindle motor does not exit through the circular gap such that the contamination is contained within the spindle motor.

Composition and Characteristic of Hard Disk Driving Device

FIG. 3 is a schematic view of a hard disk drive 101 including the spindle motor 1.

The hard disk drive 101 includes the spindle motor 1, a recording disk 103, a head locating member 104, and the housing 102 which encloses the spindle motor 1, the recording disk 103, and the head locating member 104. The inside space of the housing 102 is an extremely clean space with minimal dust particles. The base 10 of the spindle motor 1 abuts and is fixed to an inner surface of the housing 102, and the spindle motor 1 is connected with the housing 102. The recording disk 103 is a disk shaped member on which information is recorded magnetically. The recording disk 103 fits onto an outer circumferential surface of the boss portion 21a arranged on the rotor hub 21 of the rotation member 3 of the spindle motor 1.

The head locating member 104 reads/writes information from/to the recording disk 103. The head locating member 104 includes a head 105, an arm 106, and an actuator portion 107. The head locating member 104 is fixed on the housing 102 and is connected with housing 102. Therefore, each component of the head locating member 104 is connected to the base 102.

The head 105 is arranged on one end of the arm 106 so as to be adjacent to the recording disk 103 and reads/writes information from/to the recording disk 103. The arm 106 is a supporting member which supports the head 105. The actuator portion 107 can move the arm 106 to locate the head 105 on an exact location on the recording disk.

The recording disk 103 is read/written as follows. In the hard disk drive 101, the recording disk 103 rotates with the rotation of the spindle motor 1. The actuator portion 107 moves the arm 106 to locate the head 105 on the exact location on the recording disk.

The high cleanliness has to be maintained within the housing 102 of the hard disk driving device including the spindle motor 1. If the cleanliness is not properly maintained, oil and dust particles may stick to the recording disk and the head 105, and may end up causing a reading/writing error. Therefore, it is necessary to maintain the high cleanliness of each component of the hard disk driving device 101 (mainly, the spindle motor 1, the recording disk 103, and the head locating member 104). Especially, for a hard disk driving device using perpendicular magnetic recording, it is necessary to maintain extremely high cleanliness of each component.

As mentioned above, the high cleanliness of the spindle motor 1 has to be maintained until and during the assembly process of the hard disk driving device 101. In order to maintain the cleanliness of the spindle motor 1, the spindle motor 1 is preferably assembled as follows.

Assembly of the Spindle Motor

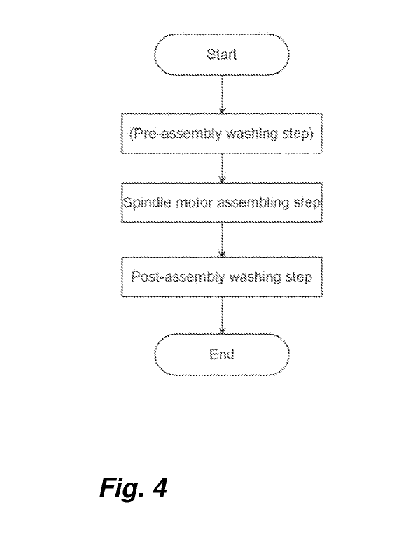

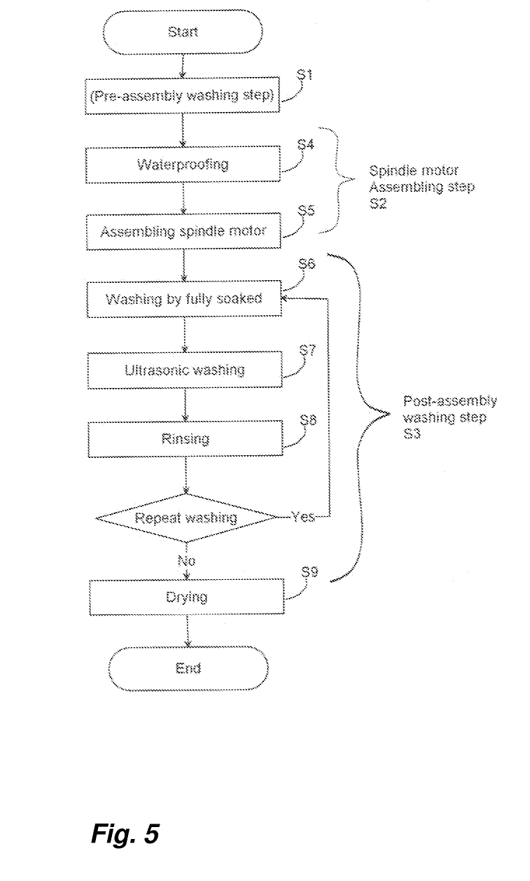

FIG. 4 schematically shows the steps of assembling the spindle motor according to a preferred embodiment of the present invention. FIG. 5 shows the specific steps of assembling the spindle motor according to a preferred embodiment of the present invention.

As shown in FIG. 4, the method of manufacturing a spindle motor according to a preferred embodiment of the present invention includes the pre-assembly washing step, the spindle motor assembling step, and the post-assembly washing step.

Referring to the FIG. 5, the detail of each step is described below. First, the components which define the spindle motor 1 are washed respectively, if required. For example, components which are to be preferably fixed by adhesives, such as the stator and the rotor magnet, and components into which the lubricating oil is filled, such as bearing components, need to be washed. However, it is not necessary to wash all components of the spindle motor 1. Purified water or a solution containing detergent is preferably used as the cleaning liquid for washing. In a method of washing the components, a cycle including a cleaning step, an ultrasonic cleaning step, a rinse step, and a drying step of the components which are put in a cleaning basket may be repeated (the pre-assemble washing step S1).

Subsequently, the components defining the spindle motor 1 are assembled into the spindle motor 1 in a clean room (cleanliness of the clean room is around Class 100) (the spindle motor assembling step S2). Alternatively, the components may be assembled into the spindle motor 1 in a clean bench (about Class 100) in a normal environment. The assembling process of the spindle motor 1 may be divided into several steps and each step of the assembling process may be carried out separately. The components defining the spindle motor may be waterproofed (step S4), then the components may be assembled into the spindle motor assembly (step S5).

After the spindle motor assembling step S2, precision cleaning is carried out with the cleaning liquid (the post assembly washing step S3). The cleaning liquid and the method of cleaning are preferably the same as the pre-assembly washing step S1. The purified water or the solution which contains detergent is preferably used as the cleaning liquid. In a method of washing the components, a cycle including the cleaning step S6, the ultrasonic cleaning step S7, the rinse step S8, and the drying step S9 of the spindle motor which are put in the cleaning basket may be repeated. The spindle motor 1 to be washed has waterproof structure at portions through which the cleaning liquid could flow into the spindle motor 1. With the waterproof structure, however, water does not flow into the spindle motor such that short-circuits of an electric circuit within the spindle motor may be prevented. The electric circuit is, for example, the circuit between the stator 6 and the rotor magnet 7 arranged within the spindle motor 1 to generate torque to rotate the rotation member 3.

As mentioned above, the occurrence of adverse effects on the bearing portion 4 during the post-assembly washing step may be prevented. In addition, with the waterproof structure arranged around the gaps through which the cleaning liquid could flow into the spindle motor, the cleaning liquid does not flow into the spindle motor 1 even if the spindle motor 1 is washed while inclining. Preferably, the temperature for the drying step S9 is preferably from about 80° C. to about 120° C.

As mentioned above, the dust particles which stick to an outside of the spindle motor may be washed out after assembling thereof. In addition, volatile compounds remaining within the motor may be removed during the drying step S9.

As mentioned above, the outer surface of the spindle motor may be washed after assembling thereof. Moreover, the dust particles inside the motor are contained within the spindle motor. Therefore, the high cleanliness of the outside space of the spindle motor may be maintained. Moreover, all components defining the spindle motor do not have to be washed before the motor is assembled, such that the assembling process of the spindle motor may be simplified. Moreover, in the method according to the present preferred embodiment, all steps of assembling the spindle motor do not have to be carried out in one large scale clean room. For example, the assembling process may be suspended after the process of fixing the rotor magnet 7 to the rotor hub 21 or the process of fixing the stator 6 to the base 10, then the assembling process may be resumed at another location.

The spindle motor 1 may be washed before or during assembling the hard disk driving device 101. As mentioned above, the inside space of the housing 102 needs to be provided as an extremely clean space with only minimal dust particles. With the spindle motor washed before or during the assembling process of the hard disk driving device, the hard disk driving device with an extremely clean inside space may be provided.

Other Referred Embodiments

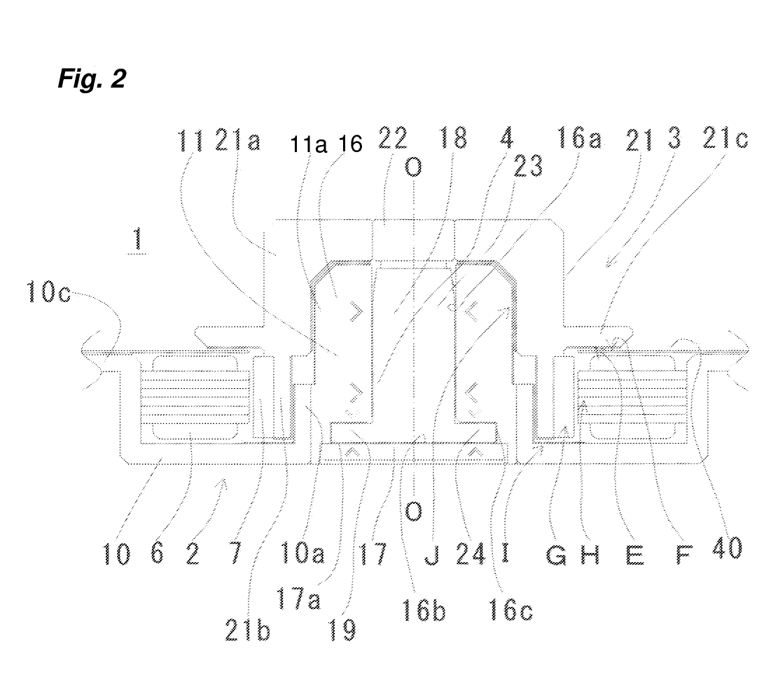

Although preferred embodiments of the present invention have been described and illustrated in detail, it is clearly understood that various modifications can be made without departing from the spirit and the scope of the present invention. In the aforementioned preferred embodiments, the spindle motor is an outer rotor motor. However, the present invention may be applied to inner rotor motors as shown in FIG. 2.

FIG. 2 is a longitudinal sectional view showing a spindle motor 1 according to another preferred embodiment of the present invention. Similar to the spindle motor 1 shown in FIG. 1, the spindle motor 1 preferably includes a stationary member 2, a rotation member 3, and a dynamic bearing 4 which rotatably supports the rotation member 3 relative to the stationary member 2. The spindle motor 1 also includes a stator 6 and a rotor magnet 7. The stator 6 is defined by a stator core fixed on the stationary member 2 and a coil winding around the stator core. The rotor magnet 7 is fixed to the rotation member 3. The stator 6 interacts with the rotor magnet 7 such that a rotating magnetic field is generated. As a result, torque is applied to the rotation member 3.

Stationary Member

The stationary member 2 preferably includes a base 10, a sleeve 11, and a magnetic shield 40 which shields flux leakage. The sleeve 11 is fitted and fixed to a fixing bore which is provided at a middle portion of the base 10. The base 10 is preferably made of an aluminum alloy, the sleeve 11 is preferably made of stainless steel, and the magnetic shield 40 is defined by a sheet shaped member made of a magnetic material, such as iron.

The base 10 is a substantially cup shaped member including a flange portion 10c, and a lower surface of the base 10 is fixed to a bottom wall of a housing 102 of a hard disk drive 101 (see FIG. 3). On a peripheral portion of the fixing bore, a cylindrical portion 10a extends in the axially upward direction. An inner circumferential surface of the cylindrical portion 10a is fixed to an outer circumferential surface of the sleeve 11 and these elements are preferably fixed together with adhesive. The stator 6 is fixed to an inner surface of the outer circumferential wall of the base 10.

The sleeve 11 includes a sleeve body 16 having a hollow cylindrical shape and a thrust cover 17 having a disk shape which occludes a bottom end of the sleeve body 16. The sleeve body 16 includes a through hole 18 which axially extends along a central axis of the sleeve body and has an inner circumferential surface 16a. The thrust cover 17 is a disk shaped member which is fixed to the bottom end of the sleeve body 16 so as to occlude a bottom opening of the through hole 18. A step portion 19 that is continuous from the inner circumferential surface 16a is provided at the bottom end of the sleeve body 16. The step portion 19 includes a thrust surface 16b which is a bottom end surface of the sleeve body 16 and a bottom inner circumferential surface 16c whose diameter is larger than a diameter of the inner circumferential surface 16a, such that the step portion 19 defines a circular convex space into which a thrust flange 24 of a shaft 22 is inserted. A lower side of the step portion 19 is occluded with a thrust surface 17a which is an axially upper end surface of the thrust cover 17. Therefore, the sleeve 11 is defined by the cylindrical hollow portion defined by the inner circumferential surface 16a of the sleeve body 16, the step portion 19 of the sleeve body 16, and the thrust cover 17. The sleeve 11 also includes the disk shaped hollow portion whose diameter is larger than the diameter of a cylindrical hollow portion.

The magnetic shield 40 which shields the flux leakage is attached to the flange portion 10c of the base 10. A radially outward portion of the magnetic shield 40 is fixed to the base 10, and a radially inward portion of the magnetic shield 40 extends radially inwardly so as to be adjacent to an inner circumferential portion of the stator 6. An upper portion of a radially inward portion of the magnetic shield 40 faces the flange portion 21c of the rotor hub 21 with a gap maintained therebetween.

Rotating Members

The rotation member 3 is a member rotatably supported by the dynamic bearing 4 relative to the stationary member 2. The rotation member 3 includes the rotor hub 21 on which the recording disk 103 is placed and the shaft 22 which is arranged at an inner circumferential side of the rotor hub 21 and is supported by the sleeve 11 via the dynamic bearing 4.

The rotor hub 21 is a cup shaped member that includes the flange portion 21c and is arranged adjacent to the sleeve 11 and the stator 6 so as to cover the sleeve 11 and the stator 6 from an upper side thereof. An inner circumferential surface of a boss portion 21a of the rotor hub 21 faces an upper outer circumferential surface of the sleeve 11 with a gap maintained therebetween. The rotor magnet 7 is fixed to an outer circumferential surface of a lower cylindrical portion 21b by any suitable bonding structure, such as adhesive. A recording disk 103 is fixed to a position on an outer circumferential surface of the boss portion 21a and above the flange portion 21c.

The rotor magnet 7 radially faces the stator 6 with a gap maintained therebetween. When the coil of the stator 6 is energized, the stator 6 electromagnetically interacts with the rotor magnet 7. As a result, torque acts on the rotation member 3.

An axially upper end portion of the shaft 22 is fitted into a central bore of the rotor hub 21. A thrust flange 24 is integral with a bottom end of the shaft 22. The shaft 22 is defined by the thrust flange 24 and a shaft body 23 having a cylindrical shape.

Characteristic of the Spindle Motor

According to the present preferred embodiment of the present invention, the following portions of the spindle motor 1 are waterproofed.

A bottom surface of the flange portion 21c which faces the magnetic shield 40 of the rotor hub 21 with a gap maintained therebetween is preferably circularly covered with water-repellent paint, such as U-CP-70 (made by Nippon Paint Co., Ltd.), so as to have water-repellency (a first waterproof structure E). An upper surface of the magnetic shield 40 is preferably covered with a water-repellent material so as to have water-repellency (the second waterproof structure F). A portion of a surface of the rotor magnet 7, which is exposed to the outside air, is covered with a coating material (such as epoxy resin) so as to have water-repellency (a third waterproof structure G). The stator 6 facing the rotor magnet 7 with a gap maintained therebetween is preferably covered with water-repellent resin (a fourth waterproof structure H). A portion of an upper surface of the bottom of the base 10 and an inner circumferential surface of the cylindrical portion 10a, which faces a bottom end surface of the rotor magnet 7 and a bottom outer circumferential surface of the rotor hub 21, is preferably circularly covered with a water-repellent material so as to have water-repellency (a fifth waterproof structure I). An upper portion of an outer circumferential surface 11a of the sleeve 11 facing the rotor hub 21 is preferably circularly covered with a water-repellent material so as to have water-repellency (a sixth waterproof structure J).

Suitable water-repellent materials are, for example, CYTOP® (Asahi Glass Company, Limited), INT-340 (NI Material, Ltd), Fluorocoat (Seimi Chemical, Ltd), and such materials may be used in the present preferred embodiment of the present invention.

Additionally, a bottom portion of the outer circumferential surface of the rotor hub 21 facing the fifth waterproof structure I may be covered with a water-repellent material. A portion of the inner circumferential surface of the rotor hub 21 facing the sixth waterproof structure J of the sleeve 11 may be covered with water-repellent material as well. The waterproof structure may be a layer provided on the surface of the members. For example, excellent water-repellency may be advantageously attained by forming the layer by a fluoro compound having a perfluoroalkyl group.

Alternatively, the waterproof structure may be formed by hydrophilic material such as a hydrophilic metal or a hydrophilic resin. Hydrophilicity of the surface of the members inhibits water from flowing on the surface such that water does not flow into the motor.

Each gap dimension at which the waterproof structure is provided is preferably about 0.5 mm, and more preferably, each gap dimension is preferably about 0.2 mm. A static contact angle with water of each surface of the waterproof structure is preferably greater than about 20 degrees. With the static contact angle which is greater than about 20 degrees and the gap dimension which is smaller than about 0.5 mm, a sufficient waterproof property may be attained.

As mentioned above, the most outward portion of the gaps through which water and air could flow into the motor has a waterproof property either on the surface of the stationary member 2 or on the surface of the rotation member 3.

The spindle motor 1 includes a magnetic circuit portion which is defined by the stator 6 and rotor magnet 7 and generates torque applied to the rotation member 3. The magnetic circuit portion is enclosed within the base 10 and the rotor hub 21. The most outward portion of the gaps connecting the inside and the outside of the spindle motor, in other words, the portion of the base 10 where the first waterproof structure E faces the rotor hub 21 with the gap maintained therebetween, has a substantially circular shape, and a cleaning liquid (such as purified water) does not flow into the spindle motor 1 through this portion.

As shown above, the cleaning liquid does not flow into the spindle motor 1, especially into the dynamic bearing 4, when the spindle motor 1 is washed after assembly thereof. Moreover, the cleaning liquid does not remain in the spindle motor such that the possibility that gas is emitted is decreased. The steps of assembling the spindle motor 1 may be the same as described above.

In the aforementioned preferred embodiments, the spindle motor includes the shaft which is preferably fixed to the rotating member and rotates with the rotation member. However, the present invention may be applied to a spindle motor whose shaft is fixed to the stationary member.

In the aforementioned preferred embodiments, the dynamic bearing 4 is preferably used as a bearing of the rotation member 3. However, a ball bearing may be used as a bearing of the rotation member 3.

In the aforementioned preferred embodiments, the base 10 and the housing 102 are preferably separate members. However, the base 10 and the housing 102 may be an integral, single piece member.

The dynamic pressure generating grooves defining each dynamic bearing portion may be provided on either opposing surface defining the gap at the dynamic bearing portions.

In the aforementioned preferred embodiments, the sleeve 11 is preferably made of stainless steel. However, the sleeve 11 may be made of any suitable metal, such as, copper, copper alloy, and free-cutting stainless steel. In the aforementioned preferred embodiments, the base 10 is preferably made of an aluminum alloy. However, the base 10 may be made of any suitable metal.

In the aforementioned preferred embodiments, the sleeve 11 is preferably fixed to the base 10 by an adhesive. However, the sleeve 11 may be fixed to the base 10 by any suitable structure or method.

While a suitable method of washing the spindle motor according to the present preferred embodiment of the present invention has been described, the method of washing the spindle motor is not limited to those preferred embodiments described above. Any suitable method of washing the spindle motor with the cleaning liquid may be used in the present invention. For example, the spindle motor according to another preferred embodiment may be washed by submerging the spindle motor or a potion of the spindle motor in the cleaning liquid. The spindle motor may be washed by spraying the cleaning liquid. Moreover, the ultrasonic washing may be carried out by submerging the spindle motor or a portion of the spindle motor.

While suitable materials for waterproofing have been described in the aforementioned preferred embodiments, the materials for waterproofing are not limited to those described above. Any suitable materials may be used for waterproofing.

While suitable positions to which the waterproof structures are applied are described in the aforementioned preferred embodiments, the positions are not limited to those described above. For example, the base 10 may be completely covered with waterproof materials.

The spindle motor according to various preferred embodiments of the present invention may preferably be used for a recording disk driving device using perpendicular magnetic recording, which requires an extremely high cleanliness of the inside space of the housing.

A flexible printed circuit (FPC), which is a sheet shaped member attached to the spindle motor to connect the spindle motor and other members such as a driving circuit portion of the recording disk driving device, may be attached to the spindle motor according to another preferred embodiment of the present invention after the spindle motor is assembled and washed.

In the aforementioned preferred embodiments, the most radially outward portion at which the inside space and the outside space of the spindle motor is connected is the most radially outward portion of the spindle motor. However, the portion at which the inside space and the outside space of the spindle motor is connected may enclose the magnetic circuit portion, and this portion may differ from the most radially outward portion of the spindle motor.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of manufacturing a spindle motor including a rotor hub which has a hard disk placing portion, a base to which the rotor hub is rotatably attached via a bearing, and a coil generating a magnetic field, the coil and the bearing are enclosed within an inside space between the rotor hub and the base, the inside space of the spindle motor is connected to an outside space of the spindle motor through a substantially circular gap maintained between the base and the rotor hub, the method comprising the steps of:
assembling the rotor hub, the bearing, the coil, and the base into a motor assembly; and
washing the motor assembly by applying a cleaning liquid to at least the substantially circular gap.

2. The method of manufacturing a spindle motor as set forth in claim 1, wherein the method of washing the motor assembly includes at least one of:
ultrasonic cleaning; and
spraying the motor assembly with the cleaning liquid.

3. The method of manufacturing a spindle motor as set forth in claim 2, wherein a dimension of the gap connecting the inside space and the outside space of the motor assembly is less than about 0.5 mm, and a static contact angle of the cleaning liquid against a surface of the rotor hub and a surface of the base which define the gap is greater than about 20 degrees.

4. The method of manufacturing a spindle motor as set forth in claim 3, further comprising the step of:
attaching a flexible printed circuit to the motor assembly after the step of washing the motor assembly.

5. The method of manufacturing a spindle motor as set forth in claim 2, wherein the step of assembling the motor assembly includes the step of:
waterproofing at least one portion of the spindle motor, the at least one portion of the waterproofed spindle motor including:
at least a portion of the surface of the rotor hub and a surface of the base facing each other and defining the gap;
at least a portion of a surface of the rotor magnet exposed to outside air;
at least a portion of a stator facing the rotor magnet with a gap maintained therebetween;
at least a portion of an outer circumferential surface of a sleeve facing the rotor hub; and
at least a portion of an inner circumferential surface of the rotor hub facing the sleeve.

6. The method of manufacturing a spindle motor as set forth in claim 5, wherein the step of waterproofing includes at least one of:
applying a hydrophilic material on the portion of the spindle motor to be waterproofed;
forming a layer defined by a hydrophilic material on the portion of the spindle motor to be waterproofed;
covering the portion of the spindle motor to be waterproofed with a hydrophilic material; and
forming a hydrophilic portion in which the portion of the spindle motor to be waterproofed is formed of a hydrophilic material.

7. The method of manufacturing a spindle motor as set forth in claim 6, wherein the hydrophilic material includes at least one of a hydrophilic resin and a metallic material.

8. The method of manufacturing a spindle motor as set forth in claim 6, wherein a dimension of the gap connecting the inside space and the outside space of the motor assembly is less than about 0.5 mm, and a static contact angle of the cleaning liquid against a surface of the rotor hub and a surface of the base which define the gap connecting the inside space and the outside space of the motor assembly is greater than about 20 degrees.

9. The method of manufacturing a spindle motor as set forth in claim 5, further comprising the step of:
attaching a flexible printed circuit to the motor assembly after the step of washing the motor assembly.

10. The method of manufacturing a spindle motor as set forth in claim 5, wherein the step of waterproofing includes at least one of:
applying a water-repellent material on the portion of the spindle motor to be waterproofed;
forming a layer made of a water-repellent material on the portion of the spindle motor to be waterproofed;
covering the portion of the spindle motor to be waterproofed with a water-repellent material; and
forming the portion of the spindle motor to be waterproofed of a water-repellent material.

11. The method of manufacturing a spindle motor as set forth in claim 10, wherein the water-repellent material includes at least one of a water-repellent resin or a water-repellent metal.

12. The method of manufacturing a spindle motor as set forth in claim 10, wherein the water-repellent material includes a fluoro compound having a perfluoroalkyl group.

13. The method of manufacturing a spindle motor as set forth in claim 10, wherein a dimension of the gap connecting the inside space and the outside space of the motor assembly is less than about 0.5 mm, and a static contact angle of the cleaning liquid against a surface of the rotor hub and a surface of the base which define the gap is greater than about 20 degrees.

14. The method of manufacturing a spindle motor as set forth in claim 13, further comprising the step of:
attaching a flexible printed circuit to the motor assembly after the steps of washing the motor assembly and drying the motor assembly.

15. A spindle motor comprising:
a rotor hub including a hard disk placing portion;
a base rotatably supporting the rotor hub via a bearing; and
a coil arranged to generate a magnetic field and being enclosed within an inside space between the rotor hub and the base, the inside space is connected to an outside space of the spindle motor through a substantially circular gap maintained between the base and the rotor hub; wherein
at least one portion of the spindle motor is waterproofed, the at least one portion of the spindle motor including:
at least a portion of a surface of the rotor hub and a surface of the base facing each other and defining the substantially circular gap connecting the inside space and the outside space of the spindle motor;
at least a portion of a surface of the rotor magnet being exposed to outside air;
at least a portion of a stator facing the rotor magnet with a gap maintained therebetween; and
at least a portion of an outer circumferential surface of a sleeve facing the rotor hub.

16. The spindle motor as set forth in claim 15, wherein the waterproofed portions of the spindle motor include at least one of a waterproof material including a hydrophilic metal, water-repellent metal, hydrophilic resin, water-repellent resin, and fluoro compound; and a layer defined by a hydrophilic material on the portion to be waterproofed.

17. The spindle motor as set forth in claim 16, wherein a dimension of the gap connecting the inside space and the outside space of the motor assembly being exposed to the cleaning liquid is less than about 0.5 mm, and a static contact angle of the cleaning liquid against a surface of the rotor hub and a surface of the base which define the gap is greater than about 20 degrees.

18. A method of manufacturing a recording disk driving device including the spindle motor as set forth in claim 15, a recording disk placed on a recording disk placing portion of the spindle motor, a head locating member having a head for reading/writing information from/to the recording disk, and
a housing enclosing the spindle motor, the recording disk, and the head locating member, the method comprising:
washing the spindle motor with a cleaning liquid; and
assembling the spindle motor, the head locating member, and the recording disk into a recording disk driving assembly.

19. The method of manufacturing a recording disk device as set forth in claim 18, wherein the recording disk driving device uses perpendicular magnetic recording.
